(19) United States
(12) Patent Application Publication
(10) Pub. No.: US 2016/0277967 A1
(43) Pub. Date: Sep. 22, 2016

(54) DISTRIBUTED DATA TRANSMISSION METHOD, TRANSMISSION APPARATUS, SYSTEM AND USER TERMINAL

(71) Applicant: CHENGDU SKSPRUCE TECHNOLOGY, INC., Chengdu, Sichuan (CN)

(72) Inventors: Yongcheng LEI, Chengdu (CN); Fang WU, Chengdu, Sichuan (CN); Qian XU, Chengdu, Sichuan (CN)

(73) Assignee: CHENGDU SKSPRUCE TECHNOLOGY, INC., Chengdu (CN)

(21) Appl. No.: 14/396,803

(22) PCT Filed: May 6, 2014
(86) PCT No.: PCT/CN2014/076860

§ 371 Date: Oct. 24, 2014

(30) Foreign Application Priority Data
Jul. 24, 2013 (CN) 201310313663.4

(51) Int. Cl. H04W 28/08; H04W 4/06; H04W 72/00

(52) U.S. Cl. CPC H04W 28/085; H04W 72/005; H04W 4/06

(57) ABSTRACT

In a distributed data transmission method, through acquiring the IP address of a user terminal in a first network and a physical address of the user terminal in a second network access module, according to the acquired addresses, when downlink service of the user terminal is distributed from the first network to the second network, an IP message whose destination address is the IP address of the user terminal in the first network is encapsulated to a message in a format corresponding to the medium access layer of the second network and afterwards is transmitted to the user terminal through the second network, and since the IP address bound to the user application is not changed, it is able to achieve seamless switch of the downlink service from the first network to the second network, avoiding problems of unnecessary interruption and restart of the user application and improving user experiences.

### TECHNICAL FIELD

The present invention relates to the field of communication technology, and particularly to a distributed data transmission method and a distributed data transmission apparatus, system and user terminal.

### BACKGROUND ART

WLAN (Wireless Local Area Network) refers to a group of computers and relative apparatuses interconnected using IEEE 802.11 wireless technology, i.e., a computer local area network with wireless channels as the transmission medium. WLAN is an important complement and extension to the Wired Network approach, gradually has become a crucial component in computer networks, and is widely applied in the field in which portable data processing is needed or physical transmission medium wiring can not be conducted. With the establishment and development of the IEEE802.11 wireless network standard, wireless network technology is made more mature and complete, and has been successfully and widely applied in various industries, such as, financial securities, education, large-scale enterprises, industrial ports, government agencies, hotels, airports, armies, etc. The products mainly comprise: wireless access points, wireless network cards, wireless routers, wireless gateways, wireless bridges, etc.

WLAN mainly comprises two architectures, IBSS (Independent Basic Service Set, also called Ad-hoc) and BSS (Basic Service Set, also called Infrastructure). In the IBSS architecture, as shown in FIG. 1, user terminals communicate with each other directly through wireless connections, with no specific devices required for performing relay communication. In the BSS architecture, as shown in FIG. 2, an access point (AP) is always required between the user terminals for performing relay communication, and moreover it is possible to access Internet services through the AP.

Since the WLAN employs relatively loose technical architecture and also uses free unlicensed frequency spectrum, the WLAN is inexpensive. The WLAN has seen rapid development and deployment due to its high cost performance, and is deemed as one measure of improving local area network capacity by individual cellular network operators who take 3GPP cellular network technology as the main body of the network technology. Therefore, 3GPP association provides in its standard a combined architecture where two kinds of WLANs access the 3GPP, that is, non-trusted access and trusted access. When accessing the network in non-trusted mode, since the WLAN network is not trusted by the operator, data from a WiFi network needs to first pass through one ePDG gateway (reinforcing message data gateway) and then through the P-GW (PDN (packet data network) gateway) in the 3GPP to access the operator's own services or Internet services. When accessing the network in trusted mode, since the WiFi network is trusted by the operator, its data can directly access the operator's own services or Internet services through the P-GW. In such architecture, the user terminal can distribute part of the data traffic to the WLAN network, so as to decrease the gradually increased traffic pressure the cellular network faces.

When the user data stream switches from an LTE network (such as a cellular network) to a WiFi network (such as a WLAN) for certain reasons (e.g., network congestion and the like), the user terminal simultaneously accesses the cellular network and the WLAN network, and is assigned different IP address in each network. In such way, since the user uses different IP addresses in the LTE network and the WiFi network, according to the conventional distributed data transmission method, the IP address bound to the user application is changed, which causes problems to the user application, such as interruption, restart and the like.

### DISCLOSURE OF THE INVENTION

### (I) Technical Problems to be Solved

The technical problem to be solved by the present invention is: how to provide a distributed data transmission method, and a distributed data transmission apparatus, system and user terminal, capable of achieving seamless switch of downlink service from a first network to a second network when the downlink service of a user terminal is distributed from the first network to the second network.

### (II) Technical Solution

The technical solution of the present invention is as follows.

A distributed data transmission method comprises:

acquiring an IP address of a user terminal in a first network;

acquiring a physical address of the user terminal corresponding to an access module of a second network;

encapsulating an IP message whose destination address is the IP address of the user terminal in the first network to a message in a format corresponding to a medium access layer of the second network, according to the acquired IP address and the physical address, when downlink service of the user terminal is distributed from the first network to the second network; and

transmitting the encapsulated message to the user terminal via the second network.

Optionally, said encapsulating of an IP message whose destination address is the IP address of the user terminal in the first network to a message in a format corresponding to a medium access layer of the second network comprises: adding a medium access layer head whose destination address is the physical address of the user terminal corresponding to the access module of the second network, before the IP message whose destination address is the IP address in the first network.

Optionally, said transmitting of the encapsulated message to the user terminal via the second network comprises: transmitting the encapsulated message to the user terminal through Layer Two Tunneling Protocol and/or Level 2 Forwarding Protocol.

Optionally, the first network is a cellular network and the second network is a wireless local area network.

An embodiment of the present invention also provides a distributed data transmission method, comprising: a user terminal, through a corresponding access module of a second network, receives a message encapsulated in a format corresponding to a medium access layer of the second network; the user terminal decapsulates the message encapsulated in the format corresponding to the medium access layer of the second network to obtain an IP message, wherein the IP message has a destination address which is the IP address of the user terminal in a first network; the user terminal transmits the decapsulated message to an upper application, according to the IP address of the first network.

Optionally, reverse path filtering function of the user terminal is forbidden.

Optionally, the first network is a cellular network and the second network is a wireless local area network.

The present invention also provides a distributed data transmission apparatus, comprising:

an address acquiring module, configured to acquire an IP address of a user terminal in a first network and acquire a physical address of the user terminal corresponding to an access module of a second network;

an encapsulation transmission module, configured to encapsulate an IP message whose destination address is the IP address in the first network to a message in a format corresponding to a medium access layer of the second network, according to the IP address and the physical address acquired by the above address acquiring module, when downlink service of the user terminal is distributed from the first network to the second network, and to transmit the encapsulated message to the user terminal via the second network.

Optionally, the distributed data transmission apparatus is integrated in a multi-services data gateway.

An embodiment of the present invention also provides a user terminal, comprising: a second network access module, configured to receive a message encapsulated in a format corresponding to a medium access layer of a second network; a decapsulation module, configured to decapsulate the message encapsulated in the format corresponding to the medium access layer of the second network and received by the second network access module, to obtain an IP message, wherein the IP message has a destination address which is the IP address of the user terminal in a first network; a message transmission module, configured to transmit the decapsulated message to an upper application, according to the IP address of the first network.

Optionally, reverse path filtering function of the user terminal can be forbidden.

An embodiment of the present invention also provides a distributed data transmission system comprising the above distributed data transmission apparatus and the user terminal.

### (III) Advantageous Effects

In the distributed data transmission method provided by an embodiment of the present invention, through acquiring the IP address of the user terminal in the first network and the physical address of the user terminal in the access module of the second network, when the downlink service of the user terminal is distributed from the first network to the second network, according to the acquired addresses, the IP message whose destination address is the IP address of the user terminal in the first network is encapsulated to the message in the format corresponding to the medium access layer of the second network and afterwards it is transmitted to the user terminal through the second network, and in such way, since the IP address bound to the user application is not changed, it is possible to achieve a seamless switch of the downlink service from the first network to the second network, avoiding problems of unnecessary interruption and restart of the user application and improving user experiences.

### DESCRIPTION OF DRAWING

FIG. 1 is a schematic view of an independent basic service set in the prior art;

FIG. 2 is a schematic view of a basic service set in the prior art;

FIG. 3 is a flowchart schematic view of a distributed data transmission method in Embodiment I of the present invention;

FIG. 4 is a flowchart schematic view of the distributed data transmission method in Embodiment II of the present invention;

FIG. 5 is a schematic view of a format of an encapsulated message in Embodiment II of the present invention; and

FIG. 6 is a structural schematic view of a distributed data transmission apparatus in Embodiment III of the present invention.

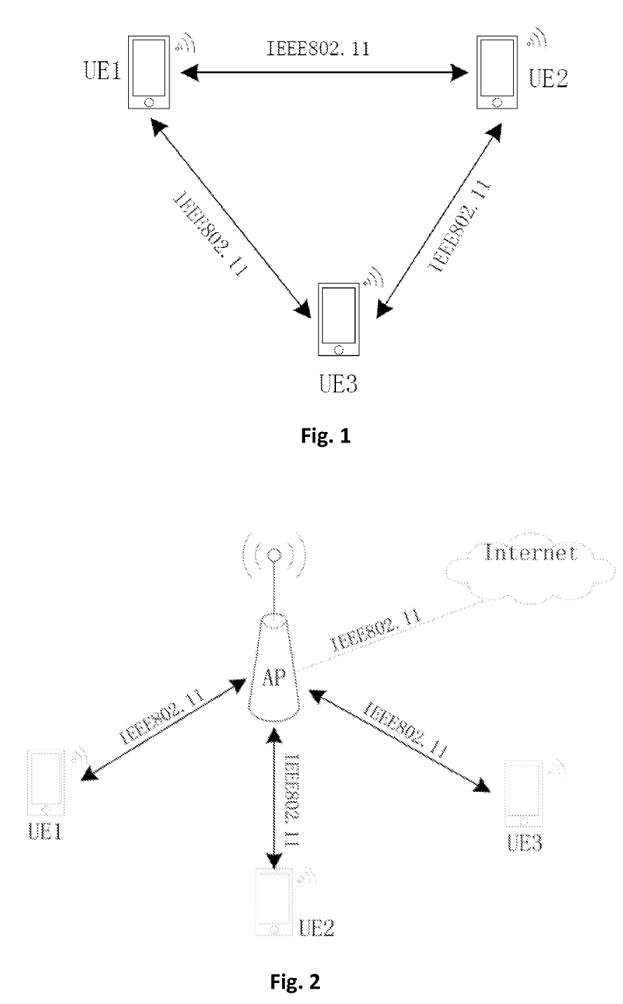

### DETAILED DESCRIPTION OF EMBODIMENTS

In conjunction with figures and embodiments below, embodiments of the present invention are described further. The following embodiments are merely provided for describing the present invention, instead of limiting the scope of the present invention.

### Embodiment I

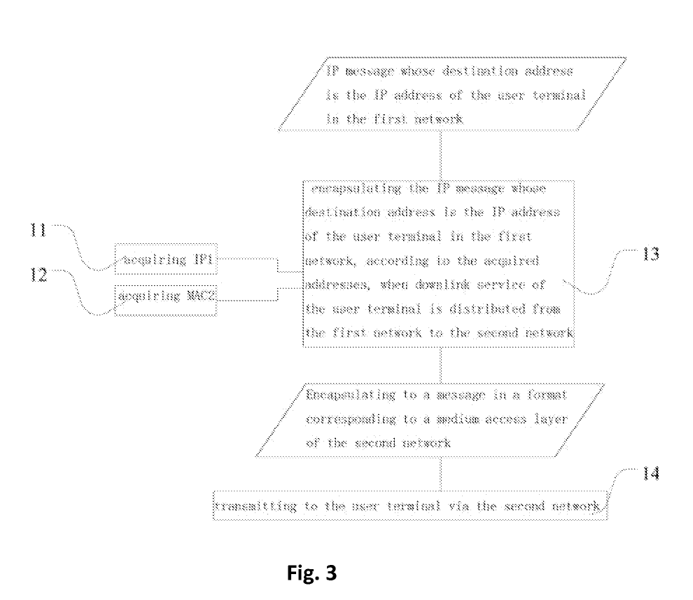

The present embodiment provides a distributed data transmission method, as shown in FIG. 3, mainly comprising the following steps:

Step 11: acquiring an IP address of a user terminal in a first network, for example, IP1 in the present embodiment;

Step 12: acquiring a physical address of the user terminal corresponding to an access module of a second network, for example, MAC2 in the present embodiment;

Step 13: encapsulating an IP message whose destination address is the IP address of the user terminal in the first network to a message in a format corresponding to a medium access layer of the second network, according to the acquired IP address and the physical address, when downlink service of the user terminal is distributed from the first network to the second network, for certain reasons of the user data stream, for example, network congestion or too low signal-to-noise ratio and the like;

Step 14: transmitting the message encapsulated in the format corresponding to the medium access layer of the second network to the user terminal.

In the above, as for the first network and the second network, it is possible that the first network is a cellular network and the second network is a wireless local area network, and alternatively the first network and the second network may be two different cellular networks, among others. The above cellular network may be: a long term evolution (LTE) network, a global system for mobile communications (GSM) network, a general packet radio service (GPRS) network, a code division multiple access (CDMA) network, a wideband code division multiple access (WCDMA) network, a time division-synchronous code division multiple access (TD-SCDMA) network and the like; the above wireless local area network may be based on IEEE802.11b protocol, IEEE802.11a protocol, IEEE802.11g protocol, IEEE802.11E protocol, IEEE802.11i protocol, a wireless application protocol (WAP), and the like. In the present embodiment, the wireless local area network is a WiFi (wireless Fidelity) network based on IEEE802.11 series protocols.

In the distributed data transmission method provided by the present embodiment, since the IP address (i.e. IP2) bound to the user application is not changed, it is able to achieve a seamless switch of the downlink service from the first network to the second network, avoiding the problems of unnecessary interruption and restart of the user application and improving user experiences.

### Embodiment II

In the present embodiment, the distributed data method provided by the present invention is described in detail, using an example in which the first network is an LTE network and the second network is a WiFi network.

Since generally the multi services data gateway (MSG) is one service joint in a Heterogeneous Network, in the present embodiment, a distributed data apparatus may be integrated in a packet multi services data gateway (MSG). Since in the present embodiment, the first network is an LTE network and the second network is a WiFi network, a first network access module of the user terminal (UE) is an LTE module and a second network access module of the user terminal (UE) is a WiFi module.

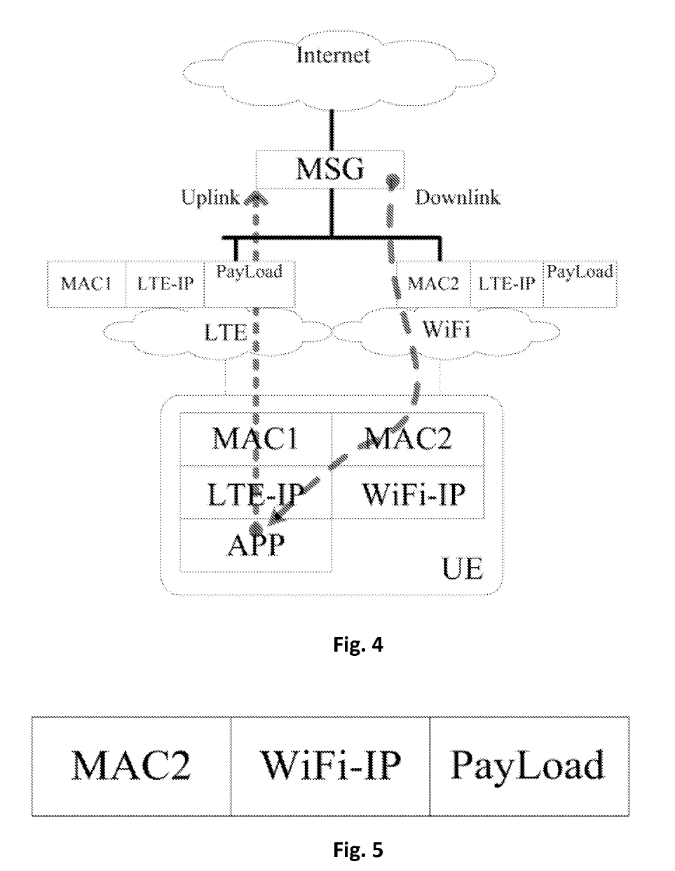

As shown in FIG. 4, the user terminal accesses respectively the LTE network and the WiFi network, with IP address, LTE-IP, in the LTE network and IP address, WiFi-IP, in the WiFi network. At the same time, the access module of the user terminal in the LTE network, i.e. the LTE module, has a physical address, MAC1; and the access module of the user terminal in the WiFi network, i.e. the WiFi module, has a physical address, MAC2.

The user application (APP) employs first the LTE-IP in the LTE network, and performs communication through the multi services data gateway (including uplink and downlink). In this multi services data gateway, there is integrated a distributed data transmission apparatus which can acquire the IP address, LTE-IP, of the user terminal in the LTE network, the physical address MAC1 of the LTE module of the user terminal, the IP address WiFi-IP of the user terminal in the WiFi network, and the physical address MAC2 of the WiFi module of the user terminal, and bind the acquired address information which is saved as a user communication address information binding table.

When the downlink service of a certain application of the user terminal is distributed from the LTE network to the WiFi network for certain reasons of the user data stream, for example, congestion in the current LTE network or too low signal-to-noise ratio and the like, the distributed data transmission apparatus encapsulates the received IP message whose destination address is the LTE-IP address to a message in the format corresponding to the medium access layer of the second network, based on the user communication address information binding table saved above. The present invention provides a particular encapsulating method which adds a medium access layer head whose destination address is the physical address of the access module of the user terminal corresponding to the second network, before the IP message whose destination address is the IP address of the user terminal in the first network. Particularly in the present embodiment, that is to add a MAC head whose destination address is MAC2, before the received IP message whose destination address is the LTE-IP address. The detailed format of the encapsulated message finally obtained is as shown in FIG. 5. In the encapsulated message, MAC2 is used as an address of a network access module of the target user terminal and the WiF-IP is used as a receiving address of the user application, and the IP message is used as PayLoad.

Next, the message encapsulated in the format corresponding to a medium access layer of the WiFi network is transmitted to the user terminal; for example, it is possible to transmit the message in the format corresponding to the medium access layer of the second network to the user terminal, through Layer Two Tunneling Protocol (L2TP) and Level 2 Forwarding Protocol (L2F), and the message in the format corresponding to the second network medium access layer is transmitted to the user terminal.

Lastly, the second network access module of the user terminal receives the message encapsulated in the format corresponding to the second network medium access layer; the message encapsulated in the format corresponding to the second network medium access layer is decapsulated; and the decapsulated message is transmitted to the upper application according to the IP address of the user terminal in the first network. Particularly, in the present embodiment, after the WiFi module of the user terminal UE receives the message encapsulated in the format corresponding to the WiFi network medium access layer based on the physical address MAC2, the message encapsulated in the format corresponding to the WiFi network medium access layer is decapsulated, wherein if it is found that the message should be transmitted to the destination address LTE-IP, then the decapsulated message is transmitted to the upper application based on the LTE-IP address of the user. It should be noted that the reverse path filtering function of the user terminal needs to be forbidden, otherwise the received message would be discarded.

In the distributed data transmission method provided by the present embodiment, since the IP address (that is, LTE-IP) bound to the user application is not changed, it is able of achieve a seamless switch of the downlink service from the LTE network to the WiFi network, avoiding the problems of unnecessary interruption and restart of the user application and improving user experiences.

### Embodiment III

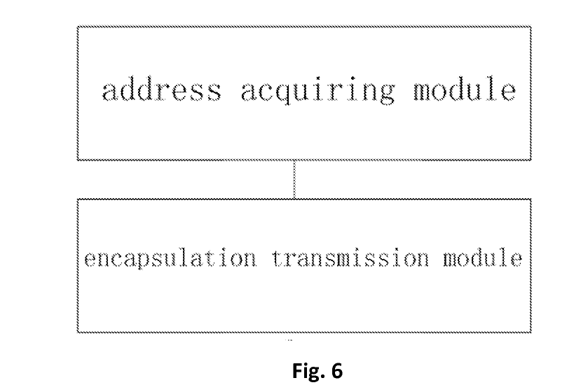

The present embodiment provides a distributed data transmission apparatus, as shown in FIG. 6, mainly comprising:

an address acquiring module, configured to acquire an IP address of a user terminal in a first network; and acquiring a physical address of the user terminal corresponding to a second network access module; and

an encapsulation transmission module, configured to encapsulate an IP message whose destination address is the IP address of the user terminal in the first network to a message in a format corresponding to a second network medium access layer and then transmit it to the user terminal through the second network, based on the acquired addresses, when downlink service of the user terminal is distributed from the first network to the second network.

Since generally the multi services data gateway (MSG) is one service joint in a Heterogeneous Network, in the present embodiment, a distributed data apparatus may be integrated in a packet multi services data gateway (MSG).

The present embodiment also provides a user terminal corresponding to the above distributed data transmission apparatus, which besides the first network access module includes: a second network access module, configured to receive the message encapsulated in the format corresponding to the second network medium access layer; a decapsulation module, connected with the second network access module and configured to decapsulate the message encapsulated in the format corresponding to the second network medium access layer and received by the second network access module, to obtain an IP message, wherein the IP message has a destination address which is the IP address of the user terminal in the first network; and a message transmission module, configured to transmit the decapsulated message to the upper application based on the IP address of the first network. Moreover, the reverse path filtering function of the user terminal can be forbidden.

The embodiment of the present invention also provides a distributed data transmission system comprising the above distributed data transmission apparatus and the user terminal.

By means of the cooperation of the above distributed data transmission apparatus and the user terminal, it is possible to achieve a seamless switch of the downlink service from the first network to the second network, avoiding problems of unnecessary interruption and restart of the user application and improving user experiences.

The above embodiments are provided merely for describing the present invention, instead of limiting the invention. The ordinary person skilled in the art, without departing from the spirit and scope of the present invention, can make various changes and variations, thus all the equivalent technical solutions are covered by the protection scope of the present invention.

1. A distributed data transmission method comprises:
acquiring an IP address of a user terminal in a first network;
acquiring a physical address of the user terminal corresponding to an access module of a second network;
encapsulating an IP message whose destination address is the IP address of the user terminal in the first network to a message in a format corresponding to a medium access layer of the second network, according to the acquired IP address and the physical address, when downlink service of the user terminal is distributed from the first network to the second network; and
transmitting the encapsulated message to the user terminal via the second network.

2. The distributed data transmission method according to claim 1, wherein said encapsulating of an IP message whose destination address is the IP address of the user terminal in the first network to a message in a format corresponding to a medium access layer of the second network comprises:
adding a medium access layer head whose destination address is the physical address of the user terminal corresponding to the access module of the second network, before the IP message whose destination address is the IP address in the first network.

3. The distributed data transmission method according to claim 1, wherein said transmitting of the encapsulated message to the user terminal via the second network comprises:
transmitting the encapsulated message to the user terminal through Layer Two Tunneling Protocol and/or Level 2 Forwarding Protocol.

4. The distributed data transmission method according to claim 1, characterized in that the first network is a cellular network and the second network is a wireless local area network.

5. A distributed data transmission method, comprising:
receiving at a user terminal, through a corresponding access module of an second network, a message encapsulated in a format corresponding to a medium access layer of the second network, wherein reverse path filtering function of the user terminal is forbidden;
decapsulating, via the user terminal, the message encapsulated in the format corresponding to the medium access layer of the second network to obtain an IP message, wherein the IP message has a destination address which is the IP address of the user terminal in a first network; and
transmitting, via the user terminal, the decapsulated message to an upper application, according to the IP address of the first network.

6. The distributed data transmission method according to claim 5, wherein the first network is a cellular network and the second network is a wireless local area network.

7. A distributed data transmission apparatus, comprising:
an address acquiring module, configured to acquire an IP address of a user terminal in a first network; and to acquire a physical address of the user terminal corresponding to an access module of a second network; and
an encapsulation transmission module, configured to encapsulate an IP message whose destination address is the IP address in the first network to a message in a format corresponding to a medium access layer of the second network, according to the IP address and the physical address acquired by the address acquiring module, when downlink service of the user terminal is distributed from the first network to the second network, and to transmit the encapsulated message to the user terminal via the second network.

8. The distributed data transmission apparatus according to claim 7, wherein the distributed data transmission apparatus is integrated in a multi-services data gateway.

9. A user terminal, of which reverse path filtering function is forbidden, comprises:
a second network access module, configured to receive a message encapsulated in a format corresponding to a medium access layer of a second network;
a decapsulation module, configured to decapsulate the message encapsulated in the format corresponding to the medium access layer of the second network and received by the second network access module, to obtain an IP message, wherein the IP message has a destination address which is an IP address of the user terminal in a first network; and
a message transmission module, configured to transmit the decapsulated message to an upper application, according to the IP address of the first network.

10. A distributed data transmission system, comprising the distributed data transmission apparatus according to claim 7 and the user terminal according to claim 9.
